(19) United States
(12) Patent Application Publication
(10) Pub. No.: US 2017/0293643 A1
(43) Pub. Date: Oct. 12, 2017

(54) METHOD AND SYSTEM FOR ENCODING INTEGRATION OF CODED LOGICAL INFORMATION SYSTEMS

(71) Applicant: Anthem, Inc., Chicago, IL (US)

(72) Inventors: Atul Apte, North Las Vegas, NV (US); Rickey Tang, Southwick, MA (US)

(21) Appl. No.: 15/413,788

(22) Filed: Jan. 24, 2017

Related U.S. Application Data
(63) Continuation of application No. 14/090,467, filed on Nov. 26, 2013, now abandoned.
(60) Provisional application No. 61/730,690, filed on Nov. 28, 2012.
(60) Provisional application No. 61/775,894, filed on Mar. 11, 2013.

(51) Int. Cl. G06F 17/30; G06Q 10/10; G06Q 40/02

(52) U.S. Cl. CPC G06F 17/30312; G06Q 40/02; G06Q 10/10; G06F 17/30

(57) ABSTRACT

Data describing code sets of multiple systems is received. The received data includes a first code set associated with a first system and a second code set associated with a second system. Equivalencies between the first code set and the second code set are determined based on (1) logical definitions associated with the first code set and logical definitions associated with the second code set and (2) one or more outputs associated with the first system and one or more outputs associated with the second system. A coding scheme is identified to standardize the codes in the first code set and the codes in the second code set. Codes of the first code set are mapped to codes of the second code set using the coding scheme.

### CROSS REFERENCE TO RELATED APPLICATIONS

This application claims priority to U.S. Provisional Patent Application No. 61/730,690 filed Nov. 28, 2012, and U.S. Provisional Patent Application No. 61/775,894, filed Mar. 11, 2013, both of which are incorporated by reference as if fully set forth herein.

### FIELD OF THE INVENTION

This invention relates to integration of codes sets used in connection with multiple systems.

### SUMMARY OF THE PREFERRED EMBODIMENTS OF THE INVENTION

Data describing code sets of multiple systems is received. The received data describes at least a first code set associated with a first system and a second code set associated with a second system. Equivalencies between the first code set and the second code set are determined based on (1) logical definitions associated with the first code set and logical definitions associated with the second code set and (2) one or more outputs associated with the first system and one or more outputs associated with the second system. A coding scheme is identified to standardize the codes in the first code set and the codes in the second code set. Codes of the first code set are mapped to codes of the second code set using the coding scheme.

In some embodiments, a first coding scheme is identified to standardized at least one of the codes in the first code set and at least one of the codes in the second code set, and a second coding scheme is identified to standardized at least one other of the codes in the first code set and at least one other of the codes in the second code set.

In other embodiments, grading the equivalencies between the first code set and the second code set are graded.

### BRIEF DESCRIPTION OF THE DRAWINGS

FIG. 1 illustrates problems that arise in encoding integration of coded systems;

FIG. 2 illustrates an example of encoded logical systems;

FIG. 3 illustrates types of code sets in a logical system;

FIG. 4 illustrates exemplary components of a code set;

FIG. 5 illustrates an example of codes, a code scheme and an encoded logical system;

FIG. 6 illustrates an exemplary approach for encoding integration of coded logical systems;

FIG. 7 is an exemplary system that can be used for carrying out the embodiments of the present invention; and

FIG. 8 is illustrates an example of how the systems and methods of the present invention can be used.

### DETAILED DESCRIPTION

Described herein is a method and system for encoding integration of two or more coded information systems. Information systems use codes to represent data, actions, events, and behavior with the objective of reducing the systems' memory and storage footprints and increasing the overall processing efficiency of the systems.

Codes and coding/decoding processes are used in all major systems including, electrical, mechanical, chemical, and logical systems.

The disclosed method and system are improvements to current methodologies for capturing the definition of codes embedded in logical information systems and using the code definitions to facilitate integration of multiple coded systems. Externalization of system codes into a stand-alone or common repository facilitates analysis of coded system behaviors, actions, events, and data. The analysis performed independent of the actual systems is useful, e.g., in detecting and isolating system integration affinities and discrepancies.

The disclosed method and system allow for capturing and standardizing enterprise system code sets across many business domains (e.g., in the healthcare space, member, claims, provider, product, customer service, sales, marketing, and finance).

When integrating two or more coded systems, a few problems that recur frequently are predominantly caused by the following factors:

A coded system's code set (Coding scheme+Codes) is usually designed and implemented in isolation from other coded systems. This results in the possibility of two coded systems that use similar code sets to code different or variant system behaviors, events, data, and actions. For example, HTML compliant web browsers use HTML codes set (tags) to implement browser functionality (behavior, actions, events, and data). Although the web browser's basic functions remains the same, different browsers exhibit different behaviors for the same HTML code set. For example, Apple Safari, Google Chrome, Firefox, and Microsoft Internet Explorer web browsers support HTML5 tags; however, each web browser has different behaviors in terms of how the browser functions. Alternately, there is also the possibility of coded systems that have similar behaviors, events, data and actions, but use different code sets. For example, two claim systems process the same set of claims using different ICD code sets. ICD 9 and ICD 10 are two completely different code sets for coding medical diagnosis and medical procedures, but could be used to create similar outcomes in different claims processing systems.

Integration of coded systems depends on accurate discovery and mapping of coded behaviors, actions, events, and data. Inconsistent coding of systems makes the task of finding equivalent system behaviors, events, data, and actions complicated and error prone. This inconsistent coding occurs when coding of one system is partial (incomplete) or different relative to other functionally similar systems.

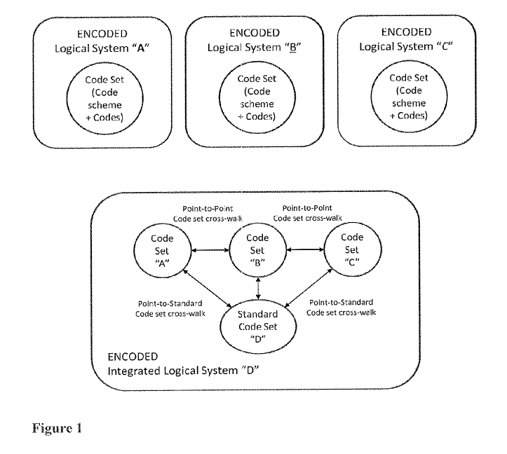

FIG. 1 illustrates three systems (A, B, and C) each of which is an independent, encoded logical system. This means that systems A, B, and C have codes embedded in their logical flows. These codes drive or represent the individual system's behavior (Functional and Non-functional), actions, events, and data. Every code is an abbreviation created to increase the system's efficiency and performance.

The integration as an encoded logical system (as illustrated by system D) depends on accurate mapping of code sets. This mapping is usually captured as a bi-directional cross-walk between two code sets and requires codes in one code set (e.g. Code Set A) be mapped to equivalent codes in other non standard code sets (e.g. Code Set B) or standard code sets (e.g. Code Set D).

Specifically, by way of example, the following problematic scenarios need better solutions. Capturing, maintaining, and refreshing standard code sets is complicated, especially when one or more of the integrated coded systems needs to be replaced. Standard code sets need to be refreshed when a new coded system needs to be integrated with a set of previously integrated coded systems. Standard code sets need to be captured when codes in the standard code set do not completely represent the code sets of all integrated coded systems. The process of discovering equivalency between codes or code sets is a common problem found in all the foregoing problem scenarios.

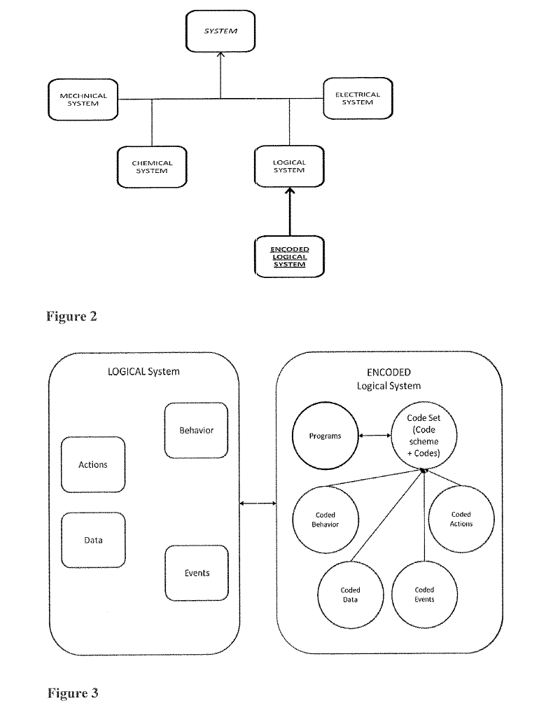

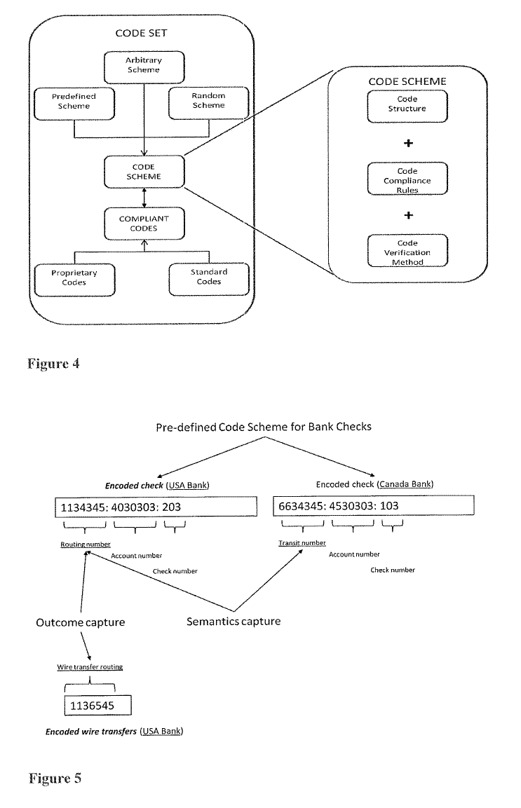

One embodiment described herein relates to code sets embedded in local systems, which are referred to as Encoded Logical Systems, as shown in the example of FIG. 2. An encoded logical system has a code set (one or many codes/abbreviations) embedded in the logical flow of all or parts of the system's computer programs. At a high level, these parts include logical system behaviors (functional and non-functional system behaviors), actions (transactions, services), events, and data. Each code set is comprised of two components: a code scheme and a set of codes compliant with the code scheme. The code scheme can be very elaborate or very simple and the set of codes can be exhaustive (all currently implemented and future codes) or trivial (minimum codes). FIG. 3 is illustrative.

Encoding of a logical system can happen in parts (e.g., encoding behaviors or actions). Alternately, partial or complete encoding of all parts of a logical system is also possible. The system (encoded integration of systems) and method (discovering, capturing, maintaining, and refreshing standard code sets) is capable of encoding and standardizing integration of multiple encoded logical systems.

A new model of code sets drives the system and method for encoding integration of coded logical systems described herein. In this new model, every code set has a consistent internal structure as illustrated in FIG. 4. The structure has two components: a code scheme and a set of compliant codes. Each code set can have 1 or many code schemes, where each code scheme can be one of three types, in an exemplary embodiment: (1) arbitrary code scheme where human judgment plays a decisive role in determining code compliance; (2) random code scheme where code compliance is deliberately randomized to improve security of codes; and (3) predefined code scheme where code compliance is determined by a set of static constraints that are effective and immutable at all times.

Code sets and compliant codes can be either proprietary (e.g., defined and implemented in the systems of a given business only) or standardized (defined by a standards body and implemented in systems within and outside of the business). In some instances, a code set is comprised of proprietary and standardized codes while, in other instances, a code set is comprised entirely of proprietary or entirely standardized codes.

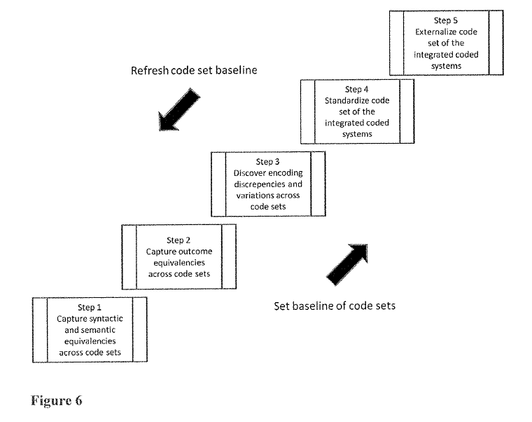

The methodology enables a code set to contain one or more code schemes with associated proprietary and/or standardized compliant codes. This creates greater flexibility in the type of codes (proprietary or standard) that can be part of a code set. Each code scheme has three basic components—a code structure, a set of code compliance rules, and code verification methods. A code structure defines the syntax of a code and code compliance rules define specific constraints for associating a code with a code scheme. Code verification methods are automated processes that validate a code and its compliance relative to associated code schemes. FIG. 5 is an example of an encoded logical system and code set (code scheme, codes). The example highlights an encoded system involving funds transferred in banks. In the example, there are two ways to transfer funds—writing a check or initiating a wire transfer. The example shows that two banks (one in Canada and one in the US) have a similar pre-defined code scheme for encoding a check. The code scheme has a similar code structure but there is a difference (semantic variance). The US bank uses a code called a “routing number” whereas the Canadian bank uses a code called a “transit number” to identify the bank where the account exists. In addition, the US bank uses two routing codes (both based on the same code scheme), one routing code for checks, another for wire transfers. The outcome of both routing codes is the same (credit and debit of the right accounts).

One exemplary approach for encoding integration of coded logical systems is a series of steps designed to capture, standardize, and externalize an entire code set of encoded logical systems and the mapping of code sets across encoded systems, with reference to FIG. 6. In steps 1 and 2, syntactic, semantic and outcome equivalency between coded systems is captured. In step 3, encoding discrepancies and variations between coded systems are discovered. In step 4, the code set of integrated coded systems is standardized. In step 5, the code set of the integrated coded systems is externalized.

The steps illustrated in FIG. 6 create a balanced approach for finding equivalent, discrepant, and variant coded behaviors, events, actions, and data. The combination of syntactic, semantic and outcome driven equivalencies delivers more accurate mapping of codes between coded systems. The standardization step utilizes a designated code scheme to determine appropriate standards for code sets of integrated systems. The final externalization step exports standardized and proprietary code sets to a common repository, which simplifies subsequent discovery of discrepancies and variations in code sets.

The stepped approach to encoding integration enables a recursive process of standardizing and mapping code sets of a logical encoded system with a designated, standard code set. Each iteration of the stepped approach results in a new baseline of an externalized, standard code set as well as mapping of each integrated system's code set with the new baseline.

Aspects of the disclosed system and method can be summarized in three parts:

Part 1: Method of Discovering and Capturing Equivalency, Discrepancy, and Variations in Code Sets

One of the major problems of encoding integration is determining equivalency between and across code sets. There are several methods for determining equivalencies including using code syntax, semantics, and metadata. The system and method described herein extends these syntax, semantics, and metadata driven methods to include system outcomes. Essentially, the method defines two levels of equivalencies—equivalency by logical definition (similar syntax, semantics and metadata of codes) and equivalency by evidence (similar outcomes). Using the two-level approach to capture equivalency between codes in two different code sets results in accurate mapping of codes as well as identifying discrepancies and variations. Detecting discrepancies is easier when there is equivalency by logical definition but equivalency by evidence is missing. The method makes identifying discrepancies possible. Variations in code sets arise when there is equivalency in evidence (meaning two coded systems are generating the same outcome) but there is no equivalency by logical definition (the syntax, semantics or metadata of codes is different). In both instances, the method is effective in simplifying the process of detecting discrepancies and variations across code sets.

Part 2: Standardization of Code Sets Based on Selection and Utilization of a Code Scheme

Standardization of individual codes or an entire code set is a complex process involving decisions about impacts on existing and future systems. The system and method described herein enables co-existence of multiple code schemes (random code scheme, arbitrary code scheme, and pre-defined code scheme) within a code set. This creates a flexible structure where individual codes within a code set become a standard using the most appropriate code scheme for the standardization process. If human judgment is the best approach for standardizing a particular code or a set of codes, then the arbitrary code scheme is most effective. On the other hand, if specific constraints are to be enforced, then the pre-defined code scheme is most effective. In situations where it is imperative to prevent knowledge of the particular association between a code and code scheme, the random code scheme is most effective. The ability to select and utilize the most appropriate code scheme for standardizing one code or a set of codes is an aspect of the method.

Part 3: Method for Grading Code and Code Set Equivalency

A key to successful encoding of integration is ensuring accurate mapping of codes. Accurate mapping of codes and code sets depends on knowing the nature of equivalency between codes and code sets. The system and method described herein grades code and code set equivalencies by particular criteria, in one exemplary embodiment, described in the following:

Complete equivalency of two codes or two code sets. Complete equivalency is a binary state (0 or 1). A value of zero indicates two codes or code sets have equivalent definitions and evidence of outcome. A value of one indicates the absence of either equivalent definition or equivalent evidence of outcome.

Zero equivalency of two codes or two code sets. This grade indicates that a code or code set is entirely different in terms of equivalency by definition and equivalency by evidence (one of a kind) relative to other codes and code sets. Hence, such codes and code sets must remain as standalone entities.

Inconsistent equivalency of two codes or code sets. This grade indicates a code or code set has complete equivalency relative to some codes or code sets and zero equivalency relative to other codes or code sets. As a result, mapping such codes and code sets may require human intervention.

The above method of grading codes and code set equivalency ensures that mapping between codes and code sets (bi-directional cross walks) is always accurate. Complete equivalencies are always mapped and inconsistent equivalencies are mapped where applicable to create point-to-point or point-to-standard cross walks.

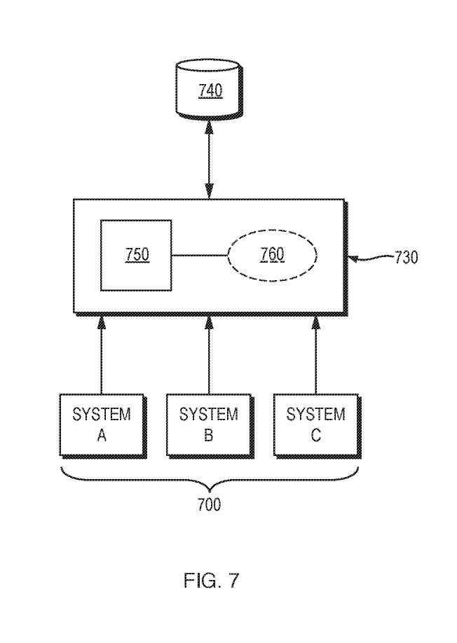

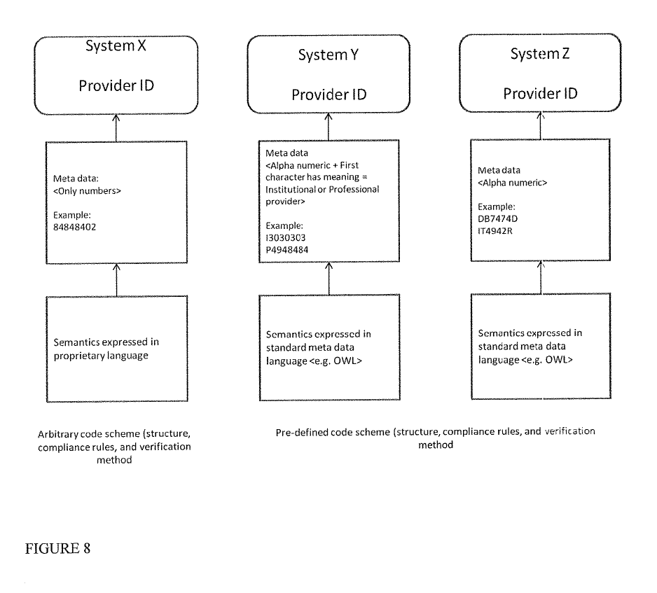

The inventions described herein may be automated and used in the exemplary system of FIG. 7. As shown, central server 730 may receive data (i.e., data describing codes and code sets) from one or more systems 700 via network 710. Central server 730 may be coupled to one or more databases 740, and include one or more processors 750, and be specially programmed with software 760 to perform the functionality described herein. The databases may be relational databases; however, other data organizational structures may be used without departing from the scope of the present invention. The non-transitory computer readable storage media that store the programs/software 760 (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

Thus, an example is described as follows. Data is received from multiple systems. The data describes codes sets of each the multiple systems. Thus, the data describes the code scheme and the associated codes of System A, the code scheme and associated codes of System B and the code scheme and associated codes of System B. Equivalencies between the code sets are determined based on logical definitions outputs associated with each of the systems. One or more coding schemes are identified to standardize the codes in each of the systems. Using the coding scheme(s), the codes in each of the systems are then mapped.

With reference to FIG. 8, a more specific example is provided in which three systems (Systems X, Y, and Z) all maintain provider identity codes. However, there are differences in the code schemes; namely, the structures of the code, compliance rules, and verification methods for the provider identities in each system. System X has provider identifiers that are only numbers and each provider identity (group of numbers) is unique from any other provider ID maintained in System X. System Y has provider identifiers that are alphanumeric and, in addition, the first character of each provider id in System Y has a special meaning. The first character indicates the category of the provider (Institutional or Professional). System Z has provider identifiers that are also alphanumeric but none of the characters have any special meaning. System Y and Z are similar from the point of view that the provider ID does not contain any provider categorization.

System X stores the provider ID code scheme in a proprietary language whereas System Y and Z use standard meta data language (e.g., OWL) to store the their provider ID code schemes. Hence, to maintain System X provider ID codes in a central code set repository, an arbitrary code scheme is necessary to verify each provider ID complies with the code System X code scheme. For Systems Y and Z, however, a pre-defined code scheme based on OWL meta data language can be used to verify the provider ID of Systems Y and Z. In the above example, a centralized provider ID code set repository will utilize both arbitrary and pre-defined code schemes to maintain the provider ID of all three Systems.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A computer implemented method comprising:
receiving data describing code sets of multiple systems, including a first code set associated with a first system and a second code set associated with a second system;
determining equivalencies between the first code set and the second code set based on (1) logical definitions associated with the first code set and logical definitions associated with the second code set and (2) one or more outputs associated with the first system and one or more outputs associated with the second system;
identifying at least one coding scheme to standardize at least one of the codes in the first code set and at least one of the codes in the second code set; and
using the coding scheme, mapping at least one code of the first code set to a code of the second code set.

2. The method of claim 1 wherein a first coding scheme is identified to standardized at least one of the codes in the first code set and at least one of the codes in the second code set, and a second coding scheme is identified to standardized at least one other of the codes in the first code set and at least one other of the codes in the second code set.

3. The method of claim 1 further comprising:
grading the equivalencies between the first code set and the second code set.

4. A system comprising:
memory operable to store at least one program; and
at least one processor communicatively coupled to the memory, in which the at least one program, when executed by the at least one processor, causes the at least one processor to:
receive data describing code sets of multiple systems, including a first code set associated with a first system and a second code set associated with a second system;
determine equivalencies between the first code set and the second code set based on (1) logical definitions associated with the first code set and logical definitions associated with the second code set and (2) one or more outputs associated with the first system and one or more outputs associated with the second system;
identify at least one coding scheme to standardize at least one of the codes in the first code set and at least one of the codes in the second code set; and
using the coding scheme, map at least one code of the first code set to a code of the second code set.

5. The system of claim 4 wherein a first coding scheme is identified to standardized at least one of the codes in the first code set and at least one of the codes in the second code set, and a second coding scheme is identified to standardized at least one other of the codes in the first code set and at least one other of the codes in the second code set.

6. The system of claim 4, wherein the processor is further caused to:
grade the equivalencies between the first code set and the second code set.

7. A non-transitory computer-readable storage medium that stores instructions which, when executed by one or more processors, cause the one or more processors to perform a method comprising:
receiving data describing code sets of multiple systems, including a first code set associated with a first system and a second code set associated with a second system;
determining equivalencies between the first code set and the second code set based on (1) logical definitions associated with the first code set and logical definitions associated with the second code set and (2) one or more outputs associated with the first system and one or more outputs associated with the second system;
identifying at least one coding scheme to standardize at least one of the codes in the first code set and at least one of the codes in the second code set; and
using the coding scheme, mapping at least one code of the first code set to a code of the second code set.

8. The non-transitory computer-readable storage medium of claim 7 wherein a first coding scheme is identified to standardized at least one of the codes in the first code set and at least one of the codes in the second code set, and a second coding scheme is identified to standardized at least one other of the codes in the first code set and at least one other of the codes in the second code set.

9. The non-transitory computer-readable storage medium of claim 7, wherein the method further comprises:
grading the equivalencies between the first code set and the second code set.
